(19) United States
(12) Patent Application Publication
(10) Pub. No.: US 2025/0356707 A1
(43) Pub. Date: Nov. 20, 2025

(54) ELECTRONIC KEY SYSTEM AND ELECTRONIC KEY MANAGEMENT METHOD

(71) Applicant: Sharp NEC Display Solutions, Ltd., Tokyo (JP)

(72) Inventors: Katsuyuki MATSUI, Tokyo (JP); Kengo TSURUZONO, Tokyo (JP)

(21) Appl. No.: 19/282,389

(22) Filed: Jul. 28, 2025

Related U.S. Application Data
(63) Continuation of application No. PCT/JP2023/034087, filed on Sep. 20, 2023.

(51) Int. Cl. G07C 9/00

(52) U.S. Cl. CPC G07C 9/00571; G07C 9/00309; G07C 2009/00769; G07C 2009/00865; G07C 2209/04; G07C 2209/08; G07C 2209/63

(57) ABSTRACT

An electronic key system includes a communication unit repeatedly performing communication at intervals with electronic devices, each having a respective electronic key assigned, to check whether each electronic device is not able to communicate with a key management server. A storage unit stores an electronic key list for each piece of lock identification information for identifying a lock device. The list includes management target electronic keys, priority levels differing for each of the electronic keys, and status information indicating whether the electronic key is valid. A status information management unit writes that one electronic key based on the priority level is valid among the electronic keys assigned to the electronic devices on the basis of a result of communication performed by the communication unit. A lock device management unit assigns keyhole data for enabling at least one of locking and unlocking operations using the validated electronic key to the management target lock device.

### BACKGROUND OF THE INVENTION

### Field of the Invention

The present invention relates to an electronic key system and an electronic key management method.

### Description of Related Art

There are electronic key solutions (also referred to as smart keys) using a smartphone as a key or the like to a door of a room, but unlocking may not be able to be performed when the smartphone serving as a key has a dead battery or it is dropped and breaks. In such a case, a technique of adding a spare key to an unlocking target itself, such as providing an input pad allowing tenkey-inputs in a door together with a smart key may be used.

Here, there are systems for managing a plurality of electronic keys (for example, Patent Document 1 and Patent Document 2).

### PATENT DOCUMENTS

[Patent Document 1] Japanese Unexamined Patent Application, First Publication No. 2019-220805
[Patent Document 2] Japanese Unexamined Patent Application, First Publication No. 2015-078536

### SUMMARY OF THE INVENTION

However, since the number of electronic keys can be increased by adding a spare key, even if one electronic device breaks, a battery is dead, or the like, a lock can be unlocked or locked using an electronic key of another electronic device. However, if the number of electronic keys is increased, a probability of theft also increases. For this reason, it is desirable to manage a plurality of electronic keys with increased security.

An aspect of the present invention is an electronic key system having a communication unit repeatedly performing communication at intervals with a plurality of electronic devices having individual electronic keys assigned thereto to check whether communication is possible with the plurality of electronic devices; a storage unit storing an electronic key list stored for each piece of lock identification information for identifying a lock device, in which the electronic key list includes management target electronic keys, priority levels differing for each of the electronic keys, and status information indicating whether or not the electronic key is valid; a status information management unit writing that one electronic key based on the priority level is valid among the electronic keys assigned to the electronic devices on the basis of a result of communication performed by the communication unit; and a lock device management unit assigning keyhole data for enabling at least one of locking and unlocking operations using the validated electronic key to the management target lock device.

In addition, another aspect of the present invention is an electronic key management method including repeatedly performing communication at intervals with a plurality of electronic devices having individual electronic keys assigned thereto to check whether communication is possible with the plurality of electronic devices; storing, in a storage unit, an electronic key list stored for each piece of lock identification information for identifying a lock device, in which the electronic key list includes management target electronic keys, priority levels differing for each of the electronic keys, and status information indicating whether or not the electronic key is valid; writing in the storage unit that one electronic key based on the priority level is valid among the electronic keys assigned to the electronic devices on the basis of a result of the performed communication; and assigning keyhole data for enabling at least one of locking and unlocking operations using the validated electronic key to the management target lock device.

According to the present invention, it is possible to manage a plurality of electronic keys with increased security.

### BRIEF DESCRIPTION OF THE DRAWINGS

FIG. 1 is a schematic system constitution diagram showing a constitution of an electronic key system S.

FIG. 2 is an explanatory schematic functional block diagram of a function of an electronic device 10.

FIG. 3 is an explanatory schematic functional block diagram of a function of a key management server 30.

FIG. 4 is a view showing an example of an electronic key list stored in a storage unit 301.

FIG. 5 is an explanatory flowchart of an operation of the key management server 30.

FIG. 6 is a sequence diagram showing a flow of processing of the electronic key system S.

FIG. 7 is a schematic functional block diagram showing a constitution of a key management server 30A.

FIG. 8 is an explanatory flowchart of an operation of the key management server 30A.

FIG. 9 is a schematic functional block diagram showing a constitution of an electronic key system SB according to a third embodiment.

### DETAILED DESCRIPTION OF THE INVENTION

Next, an electronic key system S which is an embodiment of the present invention will be described.

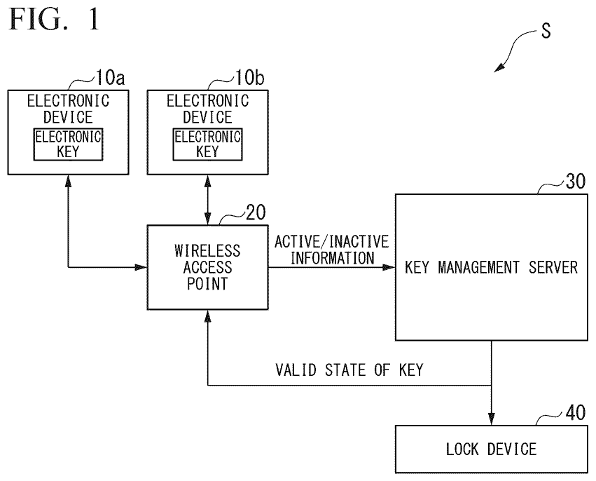

FIG. 1 is a schematic system constitution diagram showing a constitution of the electronic key system S.

The electronic key system S includes an electronic device 10a, an electronic device 10b, a wireless access point 20, a key management server 30, and a lock device 40. Hereinafter, when there is no need to distinguish between the electronic device 10a and the electronic device 10b, they may be simply referred to as the electronic device 10.

For example, the electronic device 10 may be any of a smartphone, a smartwatch, a tablet, and a dongle device. The electronic device 10 is portable.

The electronic device 10 is wirelessly connected to the key management server 30 through the wireless access point 20 so as to be able to communicate with it.

The wireless access point 20 is wirelessly connected to the electronic devices 10, the key management server 30, and the lock device 40 so as to be able to communicate with them.

The wireless access point 20 receives data transmitted from the electronic devices 10 and transmits it to the key management server 30. The wireless access point 20 receives data transmitted from the key management server 30 and transmits it to the electronic devices 10. In addition, the wireless access point 20 transmits data transmitted from the electronic devices 10 to the lock device 40 and transmits data transmitted from the lock device 40 to the electronic devices 10. In addition, the wireless access point 20 transmits data transmitted from the key management server 30 to the lock device 40.

Only one wireless access point 20 is shown in this diagram, but a plurality of wireless access points 20 may be installed at places different from each other.

In addition, at least one of the wireless access points 20 may be installed in the vicinity of (within a communicable range of) the lock device 40. In this case, the electronic device 10 which communicates with the lock device 40 can be brought to an area in the vicinity of the lock device 40 (communication partner) by a user and can communicate with the lock device 40 through the wireless access point 20 to which the lock device 40 is connected. In this case, the lock device 40 and the electronic device 10 can communicate with each other through the wireless access point 20 even if they do not have a function for direct communication such as short-range wireless communication.

The key management server 30 is wirelessly connected to the electronic devices 10 and the lock device 40 through the wireless access point 20 so as to be able to communicate with them.

The lock device 40 is wirelessly connected to the key management server 30 so as to be able to communicate with it.

The lock device 40 is attached to an object, such as a gate, a door, a window, or a lid, which can be subjected to opening/closing operations, and the lock device 40 can be switched to any state between a locked state and an unlocked state.

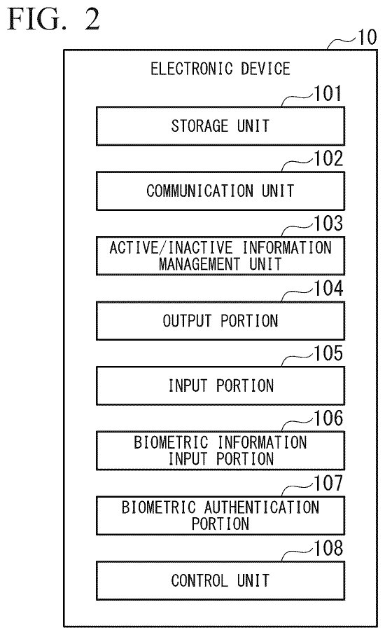

FIG. 2 is an explanatory schematic functional block diagram of a function of the electronic device 10. The function shown in FIG. 2 is provided in each of the electronic devices (the electronic device 10a and the electronic device 10b).

The electronic device 10 has a storage unit 101, a communication unit 102, an active/inactive information management unit 103, an output portion 104, an input portion 105, a biometric information input portion 106, a biometric authentication portion 107, and a control unit 108.

The storage unit 101 stores various kinds of information. For example, the storage unit 101 stores electronic device identification information for individually identifying the electronic devices 10 and electronic keys.

The communication unit 102 wirelessly communicates with the key management server 30 through the wireless access point 20. In addition, the communication unit 102 wirelessly communicates with the lock device 40 through the wireless access point 20.

The active/inactive information management unit 103 causes the communication unit 102 to transmit the active/inactive information to the key management server 30 every certain time.

The output portion 104 outputs various kinds of information. For example, the output portion 104 may be at least one of a liquid crystal display panel, a speaker, a lamp, and the like.

The input portion 105 receives an operational input from the user. For example, the input portion 105 may be at least one of a touch panel and an operation button.

The biometric information input portion 106 receives an input of biometric information used for performing biometric authentication. For example, regarding biometric authentication, an authentication method based on whether or not to match user's biometric information which has been registered in advance using one of a fingerprint, an iris, a voice (voiceprint), and the like may be adopted. Regarding the biometric information input portion 106, an input portion corresponding to the authentication method is used among a fingerprint sensor, a camera for capturing an image of an iris, a microphone for voice collection, and the like.

The biometric authentication portion 107 determines that the person is an authentic user when the matching degree between the biometric information input from the biometric information input portion 106 and the biometric information registered in advance is equal to or higher than a reference value and determines that the person is not an authentic user when the matching degree is lower than the reference value. The authentication method for biometric authentication is arbitrary and may be any of fingerprint authentication using a fingerprint, iris authentication using an iris, voice authentication (voiceprint authentication) using a voice (voiceprint), and the like.

The control unit 108 controls each portion of the electronic device 10.

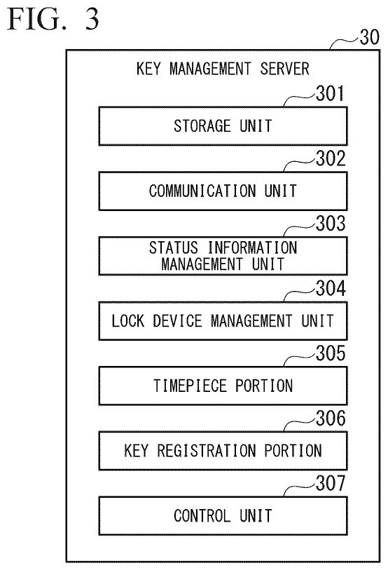

FIG. 3 is an explanatory schematic functional block diagram of a function of the key management server 30.

The key management server 30 has a storage unit 301, a communication unit 302, a status information management unit 303, a lock device management unit 304, a timepiece portion 305, a key registration portion 306, and a control unit 307.

The storage unit 301 stores an electronic key list and keyhole data.

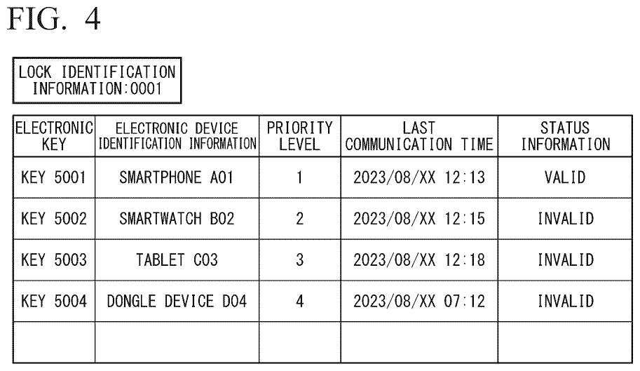

FIG. 4 is a view showing an example of the electronic key list stored in the storage unit 301.

The electronic key list is data stored for each piece of lock identification information for identifying the lock device 40.

That is, when there are a plurality of lock devices 40, the electronic key list shown in FIG. 4 is stored for each piece of lock identification information in different lock devices 40.

Here, the electronic key list includes electronic keys, the electronic device identification information, priority levels differing for each piece of the electronic key identification information, status information indicating whether or not the electronic key is valid, and the lock identification information. Here, electronic keys, electronic device identification information, priority levels, last communication times, and status information are associated with lock identification information “0001”.

The electronic keys included in the electronic key list may be the electronic keys themselves or may be the electronic key identification information. The electronic key identification information is information for identifying management target electronic keys and is information which is individually assigned.

The electronic device identification information is identification information for individually identifying the electronic devices 10.

The priority level is a value which is individually assigned and differs for each electronic key. The priority level represents an order stipulating which electronic key is to be used with priority.

The last communication time is a time when the last communication was performed with the electronic device 10 having the electronic key identification information assigned thereto, that is, the most recent time when communication was performed.

The status information is a value representing whether it is valid or invalid. A plurality of different electronic keys are associated with one piece of lock identification information. However, the status information is set as valid for only one of the plurality of different electronic keys or set as invalid for all the electronic keys.

Here, four electronic keys, “Key 5001”, “Key 5002”, “Key 5003”, and “Key 5004” are associated with the lock identification information “0001”. In this case, in the electronic key list, the electronic keys are associated to be able to perform an operation of unlocking or locking the lock device 40 having the lock identification information “0001” assigned thereto using any of these electronic keys.

In addition, for example, it is indicated that the electronic key “Key 5001” is stored in the electronic device 10 having electronic device identification information “Smartphone A01” assigned thereto, the priority level is “1”, that is, it is used with the highest priority, the last communication time is “August XX, 2023, 12:13”, and the status information is “valid”. Hereinafter, the electronic key set with the highest priority level may be referred to as a main key, and the electronic keys set with the second or lower priority level may be referred to as spare keys.

Here, it is indicated that the electronic key capable of locking or unlocking the lock device 40 is only the electronic key “Key 5001” among the four electronic keys. The user carries around at least two electronic keys of the four electronic keys. That is, the user carries around two electronic devices 10, for example, the user carries around the electronic device 10 storing the main key (for example, the electronic device 10a) and the electronic device 10 storing the spare key (for example, the electronic device 10b). In this manner, the electronic device 10 storing the spare key is carried by the user. For this reason, there is no need for it to be fixedly installed in an object such as a door. For this reason, it is possible to prevent a situation in which the spare key installed in an object is misused while the main key is in an obstructed state and the lock device is unlocked with the spare key.

In this FIG. 4, four electronic keys are associated with one piece of lock identification information. However, a plurality of electronic keys need only be associated with one piece of lock identification information. There may be two electronic keys, three electronic keys, or five or more electronic keys.

When having a correlation with the electronic key, the keyhole data is data for enabling the lock device 40 to shift to the locked or unlocked state. Here, one piece of keyhole data is generated correspondingly for each electronic key by the key management server 30 or an electronic key generation device.

Regarding the keyhole data, when an electronic key and keyhole data corresponding to the electronic key are generated by the key management server 30, this generated keyhole data may be stored. In addition, an electronic key and keyhole data corresponding to the electronic key may be generated by a different key generation device, and this generated keyhole data may be stored.

The communication unit 302 repeatedly performs communication at intervals with a plurality of electronic devices having individual electronic keys assigned thereto to check whether communication is possible with the plurality of electronic devices.

The status information management unit 303 writes that one electronic key based on the priority level is valid among the electronic keys assigned to the electronic devices 10 on the basis of a result of communication performed by the communication unit 302. In addition, the status information management unit 303 may write that all the electronic keys are invalid.

In addition, the status information management unit 303 writes that the electronic key having the highest priority level is valid among the electronic keys assigned to the electronic devices 10 on the basis of a result of communication performed by the communication unit 302.

In addition, the status information management unit 303 writes that the electronic key having the highest priority level is valid among the electronic keys whose most recent time at which communication was able to be performed by the communication unit 302 is within a range of an allowable time based on a current time. Here, when a time interval between the most recent time at which communication was possible and the current time is shorter than the allowable time determined in advance, it is possible to determine that the function of the electronic device 10 in which communication was possible is validly functioning, and when it is longer than the allowable time, it is possible to determine that the function of the electronic device 10 is not valid.

In such a case, the status information management unit 303 validates the electronic key of the electronic device 10 having the highest priority level among the electronic devices 10 which have been determined to have the time interval between the most recent time at which communication was possible and the current time being shorter than the allowable time determined in advance. Therefore, the status information management unit 303 can delegate the authority to perform locking or unlocking to the validated electronic key of the electronic device 10. Thus, the authority can be delegated by the key management server 30 instead of the electronic device 10.

In addition, when the most recent time at which communication was possible with the electronic device having the validated electronic key assigned thereto exceeds the allowable time, the status information management unit 303 invalidates the validated electronic key and validates the electronic key having the highest priority level whose most recent time at which communication was possible is within the range of the allowable time among the remaining electronic devices.

In addition, if communication is resumed with the electronic device invalidated due to exceeding the allowable time, the status information management unit 303 validates the electronic key having a higher priority level of the priority level of the electronic key assigned to the electronic device with which the communication has been resumed and the priority level of the electronic key which is currently validated, and invalidates the remaining electronic keys.

Returning to FIG. 3, the lock device management unit 304 assigns keyhole data for enabling at least one of locking and unlocking operations using the validated electronic key to the management target lock device.

The timepiece portion 305 measures the current time.

The key registration portion 306 receives registration of electronic keys and priority levels in response to an instruction from a terminal device used by the user and writes them in the electronic key list of the storage unit 301. Here, registration and deletion of electronic keys, change of the priority level, and the like can be performed. When electronic keys are registered, the key registration portion 306 can assign the electronic key identification information to the electronic keys and write it in the electronic key list.

The control unit 307 controls each portion of the key management server 30.

Next, an operation of the foregoing electronic key system S will be described.

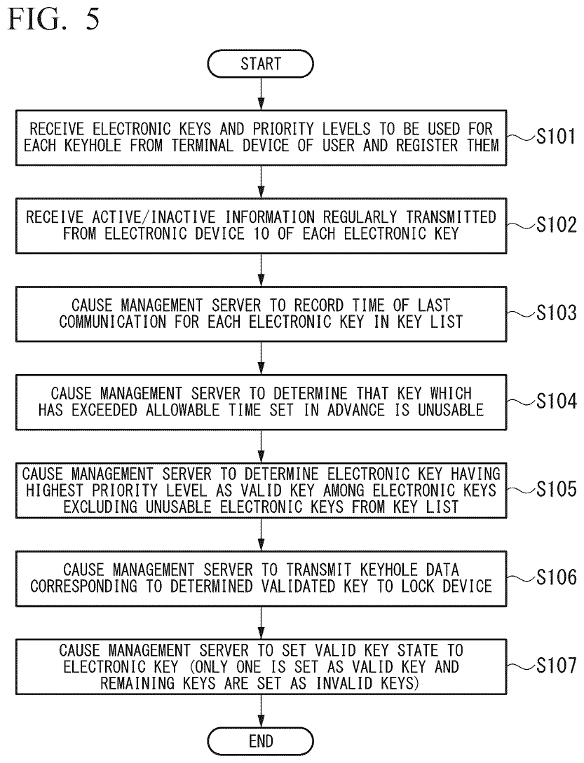

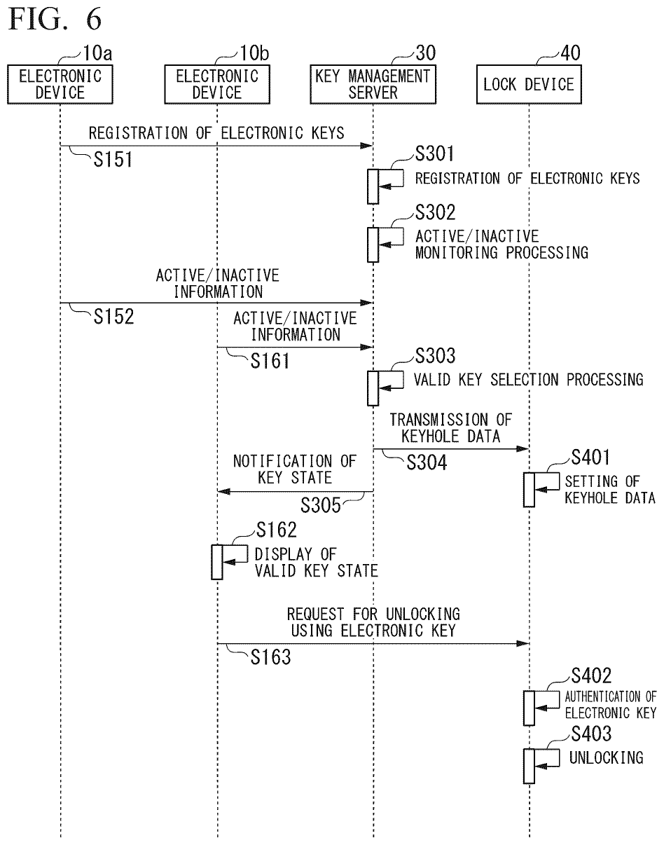

FIG. 5 is an explanatory flowchart of an operation of the key management server 30, and FIG. 6 is a sequence diagram showing a flow of processing of the electronic key system S.

First, the user registers electronic keys and their priority levels by storing them in the storage unit 301 of the key management server 30 as the electronic key list (Step S101 in FIG. 5, and Step S151 in FIG. 6). For example, the user may register electronic keys and priority levels by operating any one terminal device of a smartphone, a tablet, a PC, and the like to access a Web site for registering electronic keys in the key management server 30 from the terminal device. In addition, such a terminal device may be any one electronic device 10 of the electronic devices 10.

In addition, such a Web site may be a membership site or a key manufacturer's site. Here, the user registers each of target electronic devices which will be used by him/herself as the electronic keys to the lock device 40. For example, when the user uses four electronic devices 10 as the electronic keys, all the four electronic keys can be registered.

The key registration portion 306 of the key management server 30 registers the electronic keys and the priority levels as the electronic key list by writing them in the storage unit 301 on the basis of a registration request from the terminal device (Step S301 in FIG. 6).

If each of the electronic devices 10 is registered, the key management server 30 performs active/inactive monitoring processing based on whether or not the active/inactive information has been received from the electronic device 10 (Step S302 in FIG. 6). If there is communication from the electronic device 10, the key management server 30 can continuously detect that the electronic device 10, with which the communication has been performed, is in operation by performing the active/inactive monitoring processing.

In addition, after each of the electronic devices 10 is registered, each of the electronic devices 10 regularly communicates with the key management server 30 via the wireless access point 20 and transmits the active/inactive information (Steps S152 and S161 in FIG. 5). For example, each of the electronic devices 10 regularly transmits the active/inactive information to the key management server 30. The active/inactive information may be regularly transmitted every period of time, such as 10 minutes, for example. The intervals for transmitting the active/inactive information may be regular or random as long as it is shorter than the allowable time.

The active/inactive information need only include information allowing at least the electronic device 10 or the electronic key (transmission origin) to be ascertained. For example, using the electronic device identification information included in the active/inactive information, it is possible to identify which electronic device 10 is the transmission origin of the active/inactive information.

In the active/inactive monitoring processing, if the active/inactive information is received from the electronic device 10 (Step S102 in FIG. 5), the status information management unit 303 reads the received time from the timepiece portion 305 and writes it as the last communication time in the electronic key list in association with the key identification information included in the active/inactive information (Step S103 in FIG. 5).

If a determination timing arrives, the status information management unit 303 determines whether or not the time interval between the last communication time and the current time is within the allowable time. When the time interval between the last communication time and the current time exceeds the allowable time, the status information management unit 303 determines that the electronic key corresponding to the last communication time which has exceeded the allowable time is invalid and rewrites that the status information is invalid (Step S104 in FIG. 5).

Meanwhile, when the time interval between the last communication time and the current time does not exceed the allowable time, the status information management unit 303 extracts it as a candidate for a valid key.

The status information management unit 303 selects, as a valid key, the electronic key having the highest priority level among the remaining electronic keys in the electronic key list excluding the invalid electronic keys (Step S303 in FIG. 6).

Further, the status information management unit 303 rewrites that the status information of the electronic key selected as a valid key is “valid” and rewrites that others are “invalid” (Step S105 in FIG. 5).

For example, the electronic key of the electronic device 10a has a higher priority level than the electronic key of the electronic device 10b, and by then communication based on the active/inactive information has been possible with the electronic device 10a within the allowable time. However, when communication was not possible within the allowable time in current determination (when communication is interrupted), and when communication based on the active/inactive information was possible with the electronic device 10b within the allowable time, it is determined that the electronic key of the electronic device 10a is unusable, and the electronic key of the electronic device 10b is selected as a valid key. Accordingly, the electronic key of the electronic device 10a is changed from a usable state (valid key) to an unusable state (invalid key), and the electronic key of the electronic device 10b is changed from an unusable state (invalid key) to a usable state (valid key).

In addition, for example, after the electronic key of the electronic device 10a is changed to an invalid key, if the electronic device 10a and the key management server 30 shift to a communicable state and the active/inactive information is transmitted from the electronic device 10a to the key management server 30, the status information management unit 303 receives the active/inactive information from the electronic device 10a. When the time interval between the last communication time and the current time is within the allowable time, and when the priority level of the electronic key of the electronic device 10a is higher than the priority level of the electronic key of the electronic device 10b, the status information management unit 303 selects the electronic key of the electronic device 10a as a valid key again and makes the electronic key of the electronic device 10b unusable on the basis of this received active/inactive information.

In this manner, when the electronic device 10a of the electronic key having a higher priority level is shifted from an incommunicable state to a communicable state and determined to be valid, the electronic key of the electronic device 10a is changed from an invalid key to a valid key. Accordingly, for example, even if the user carries the electronic device 10a and travels beyond the allowable time to a region where communication with the key management server 30 is not possible, such as using the subway, it can be restored to a valid key when the user returns to a communicable region. Accordingly, it is possible to avoid a situation in which the electronic device 10a cannot be used, when it continuously remains an invalid key, even if the user returns within a communication range after he/she temporarily goes out of the communication range while carrying the electronic device, although the electronic device 10a and the key management server 30 can communicate with each other and the priority level of the electronic device of the electronic device 10a is higher than those of the electronic keys of other electronic devices.

In this manner, the key management server 30 can switch to a usable electronic key. For example, when the main key is in a valid state but the time interval between the last communication time of the electronic device 10 of the main key and the current time exceeds the allowable time, the main key is set to “invalid”, and the electronic key of the electronic device 10 with which communication was able to be performed within the allowable time among the remaining spare keys is set to “valid”. Accordingly, it can switch from the main key to the spare key.

In this manner, the status information management unit 303 can switch the electronic key by selecting, as a valid key, one electronic key having the highest priority level among the electronic keys (usable keys) excluding the “invalid” (unusable) electronic keys of the electronic keys included in the key list registered in advance.

When communication using the active/inactive information cannot be performed with all the electronic devices 10 within the electronic key list, the status information management unit 303 invalidates all the electronic keys for the sake of safety.

If a valid key is selected, the lock device management unit 304 transmits the keyhole data corresponding to the validated electronic key to the lock device 40 through the communication unit 302 (Step S106 in FIG. 5, and Step S304 in FIG. 6).

If the lock device 40 receives the keyhole data from the lock device management unit 304, it sets the received keyhole data as a lock which can be locked and unlocked (Step S401 in FIG. 6). Accordingly, the lock device 40 can perform any of locking and unlocking operations using the electronic device 10 storing the electronic lock selected as a valid key.

The control unit 307 of the key management server 30 transmits, as key state notification information, the information indicating that the electronic device 10 corresponding to the validated electronic key has been set as a valid key through the communication unit 302 (Step S107 in FIG. 5, and Step S305 in FIG. 6). Here, the control unit 307 may notify that the electronic devices 10 other than the electronic device 10 corresponding to the electronic key set as a valid key are invalid. Here, the electronic device 10 in a communicable state can receive the information indicating that it has been invalidated.

If a notification indicating that it is a valid key is received, the electronic device outputs the information indicating that the electronic key of the electronic device 10 is a valid key (Step S162 in FIG. 6). For example, a lamp serving as the output portion 104 of the electronic device 10 may be turned on, or a key mark may be displayed in a display screen of the output portion 104. Accordingly, even if the usable electronic key is switched to an electronic key of a different electronic device, the user can ascertain which electronic key of the electronic device 10 can be used. The display of whether or not electronic device 10 is a valid key may be displayed at all times during the period in which it is a valid key, may be displayed when there is an input of an inquiry from the user regarding whether or not it is a valid key, or may be displayed when an operation of locking or unlocking the lock device 40 is performed.

When the user arrives at a place in front of a door and unlocks the door, an unlocking instruction is input to the electronic device 10 storing a valid key. The electronic device 10 transmits the unlocking instruction to the lock device 40 on the basis of this unlocking instruction. Here, the electronic device 10 communicates with the wireless access point 20 with which communication is possible, and therefore the unlocking instruction can be transmitted to the lock device 40 capable of communicating with this wireless access point 20. Here, the electronic device 10 transmits the electronic key to the lock device 40 connected through the wireless access point 20 and transmits a request for unlocking (Step S163 in FIG. 6). Here, a case in which the electronic device 10 and the lock device 40 communicate with each other through the wireless access point 20 will be described, but an unlocking instruction or a locking instruction may be transmitted from the electronic device 10 to the lock device 40 through communication between the electronic device 10 and the lock device 40 by short-range wireless communication.

In the embodiment described above, when the wireless access point 20 is installed in a region where it can perform wireless communication with the lock device 40, that is, in the vicinity of the lock device 40, it is possible to avoid a situation in which the electronic device 10 and the key management server 30 cannot communicate with each other (the active/inactive information cannot be transmitted) because the wireless access point 20 is not located in the vicinity of it until the user carries the electronic device 10 and approaches a place in the vicinity of the lock device 40 for locking or unlocking. Accordingly, it is possible to avoid a situation in which the electronic key of the electronic device 10 carried by the user is invalidated because the time interval between the last communication time and the current time exceeds the allowable time until the user carries the electronic device 10 and approaches a place in the vicinity of the lock device 40.

If the electronic key is received from the electronic device 10, the lock device 40 performs authentication processing of the electronic key by determining whether or not there is a correlation between the keyhole data which is currently set in the lock device 40 and the received electronic key (Step S402 in FIG. 6). Further, if the lock device 40 determines that there is a correlation between the keyhole data and the electronic key, the lock device 40 performs unlocking in response to a request for unlocking (Step S403 in FIG. 6).

In addition, in the embodiment described above, a case in which the user carries around both the electronic device 10a and the electronic device 10b has been described, but the electronic device 10 storing the spare key may be provided in the lock device 40. Accordingly, when the user performs biometric authentication with respect to the electronic device 10b provided in the lock device 40, the spare key of the electronic device 10b can be validated and the lock device 40 can be locked or unlocked on the basis of the results of biometric authentication. In addition, even when the electronic device 10 is provided in the lock device 40, when it is determined that the user is a legitimate user through biometric authentication, the spare key can be validated, and therefore security can be ensured such that the spare key is prevented from being used even if the user does not carry the electronic device 10b.

In addition, in the embodiment described above, a case in which the keyhole data is transmitted from the key management server 30 to the lock device 40 and one piece of the keyhole data is stored in the lock device 40 has been described. However, each piece of corresponding keyhole data of the electronic key of each of the electronic devices 10 may be transmitted to the lock device 40 from the key management server 30, and each piece of the keyhole data may be stored in the lock device 40. Further, data for instructing which keyhole data is to be validated may be transmitted from the key management server 30. Accordingly, the lock device 40 may use the valid keyhole data instructed from the key management server 30 when processing of unlocking or locking is performed. Accordingly, there is no need to transmit the keyhole data every time the valid electronic key is switched, and it is sufficient to transmit data indicating which keyhole data is to be validated.

In addition, in the embodiment described above, for example, when the electronic device 10a storing the electronic key is lost, the user may operate any electronic device of the electronic device 10b and his/her own smartphone or personal computer (PC) to transmit an instruction to the key management server 30 to invalidate the electronic key of the lost electronic device 10a. If this instruction is received, the key management server 30 writes “invalid” in the status information of the electronic key of the electronic device 10a. Accordingly, the electronic device 10a can be prevented from being used by a third person unlocking or locking the lock device 40.

A case in which processing of invalidating the electronic key of the lost electronic device 10 is performed manually in this manner has been described, but it may be automatically invalidated.

Next, an electronic key system according to a second embodiment will be described. In the second embodiment, processing of invalidating the electronic key of the electronic device 10 can be performed automatically, not manually.

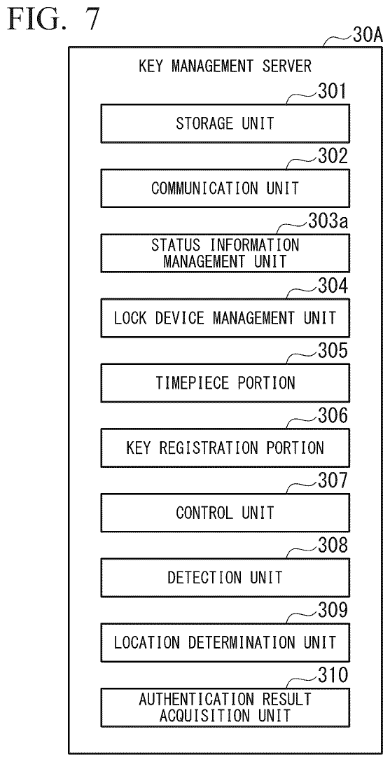

FIG. 7 is a schematic functional block diagram showing a constitution of a key management server 30A used in the electronic key system according to the second embodiment.

In the key management server 30A, the same reference signs are applied to the same functions as those of the key management server 30 shown in FIG. 3, and description thereof will be omitted.

A detection unit 308 detects the location of the electronic device of each of the plurality of electronic keys associated with the same lock identification information. A location determination unit 309 determines whether or not the distance to each detected location is within a predetermined distance. An authentication result acquisition unit 310 acquires authentication results of biometric authentication performed for the electronic device from the electronic device.

When the detected location is not within the predetermined distance, a status information management unit 303a invalidates all the electronic keys of the electronic devices on the basis of the determination results of the location determination unit 309.

On the basis of the determination results of the location determination unit 309, the status information management unit 303a validates the electronic key of the electronic device which has been authenticated as being used by an authentic user in the authentication results and invalidates other electronic keys among the electronic keys invalidated on the basis of that the detected location is not within the predetermined distance.

Next, an operation of the key management server 30A according to the second embodiment will be described.

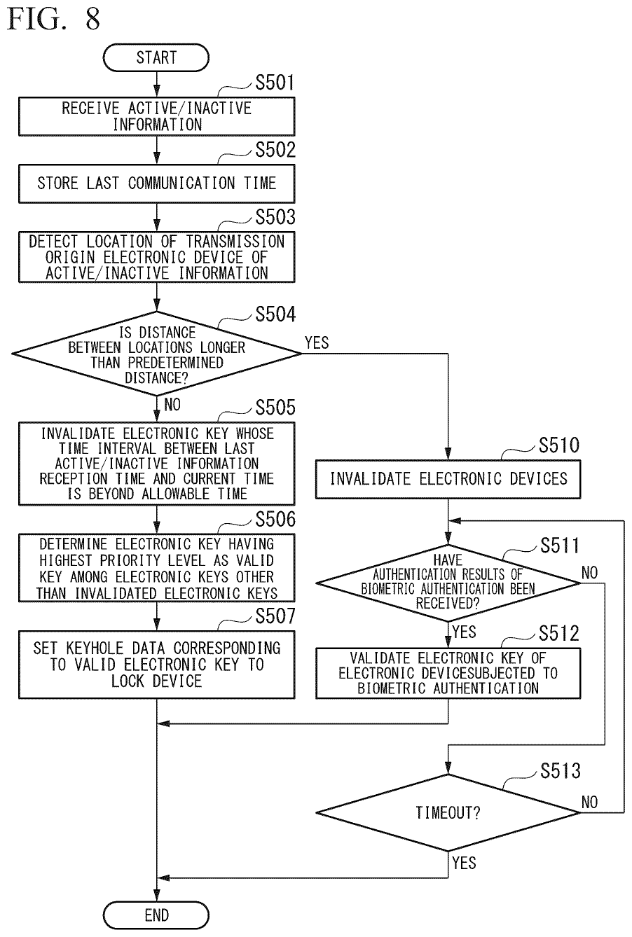

FIG. 8 is an explanatory flowchart of an operation of the key management server 30A.

If the active/inactive information is received from the electronic device 10 (Step S501 in FIG. 8), the status information management unit 303 reads the received time from the timepiece portion 305 and writes it in the electronic key list as the last communication time in association with the key identification information included in the active/inactive information (Step S502 in FIG. 8).

Here, all the electronic devices 10 are connected through the access point such that communication is possible when the active/inactive information is regularly transmitted to the key management server 30. For this reason, the location of the user carrying the electronic device 10 can be estimated on the basis of the wireless access point 20 to which the electronic device 10 is connected. For this reason, each location of the electronic device 10 storing the main key and the electronic device 10 storing the spare key can be estimated on the basis of the wireless access point 20 to which it is connected.

Here, for example, a case in which the user carries around a plurality of electronic devices 10 together, which are registered in association with one lock device, will be described.

When each of the registered electronic devices 10 transmits the active/inactive information, the status information management unit 303 identifies the wireless access point 20 via which the active/inactive information has been transmitted on the basis of the active/inactive information. Here, when the active/inactive information is received, the status information management unit 303 can also acquire information indicating the wireless access point 20 via which it has been transmitted. Further, the detection unit 308 estimates (detects) the locations of the electronic devices 10 on the basis of the wireless access point 20 via which the received active/inactive information has been transmitted (Step S503 in FIG. 8).

The location determination unit 309 determines whether or not the distance between the locations is longer than the distance determined in advance (Step S504 in FIG. 8). When it is determined that the distance between the detected locations is longer than the distance determined in advance on the basis of the determination results of the location determination unit 309 (Step S504—YES in FIG. 8), the status information management unit 303 switches all the status information of the electronic devices 10 to “invalid” (Step S510).

For example, when the active/inactive information of at least one electronic device 10 of a plurality of electronic devices 10 is received via the wireless access point 20 different from those of other electronic devices 10, there is a probability that the user has left the electronic device 10 which has been received via the different wireless access point 20 somewhere or has lost it so that it has been moved to another place. In addition, it is possible to consider a probability that the user has not moved but one of the electronic devices 10 is taken away by a third person.

In such a case, all the electronic devices 10 are set to “invalid”. In a stage in which it is detected that the electronic devices 10 are at a distance from each other, since it is not possible to identify which electronic device 10 is in hand of the original user, it is possible to prevent the electronic key from being used by a third person by setting all the electronic devices 10 to “invalid”.

Here, when the electronic devices 10 have been invalidated, the status information management unit 303 may notify each of the electronic devices 10 of that the electronic key has been set to “invalid” through the communication unit 302. Accordingly, the user can ascertain that the electronic keys of the electronic devices 10 have been invalidated.

In addition, the user who has ascertained that all the electronic devices 10 have been set to “invalid” can input the biometric information from the biometric information input portion 106 of any of the electronic devices 10 carrying by himself/herself. For example, the user inputs any one of a fingerprint, an iris, a voice (voiceprint) and the like to the electronic device 10. The electronic device 10 performs biometric authentication on the basis of the input biometric information. Further, when the matching degree between the input biometric information and the biometric information registered in advance is equal to or higher than the reference value, the biometric authentication portion 107 of the electronic device 10 determines that it has been used by an authentic user. The electronic device 10 which has been determined to be used by an authentic user transmits the authentication results indicating that it could be confirmed that it has been used by an authentic user to the key management server 30.

The authentication result acquisition unit 310 of the key management server 30A determines whether or not the authentication results of biometric authentication have been received from the electronic device 10 (Step S511 in FIG. 8).

When the authentication result acquisition unit 310 has received the authentication results of biometric authentication from the electronic device 10 (Step S511—YES in FIG. 8), the status information management unit 303a rewrites that the status information corresponding to the transmission origin electronic device 10 (for example, the electronic device 10a) in the authentication results in which it could be confirmed that it has been used by an authentic user is “valid” (Step S512 in FIG. 8).

Accordingly, it is possible to estimate the electronic device 10 which is carried by a legitimate user by performing biometric authentication, and the electronic device 10 can be validated. Accordingly, regarding the electronic device 10 located at a place at a certain distance away due to loss or the like, for instance, even if the active/inactive information could be transmitted and even when its priority level is higher than the electronic device 10 carried by a legitimate user, it can be invalidated at all times. In addition, if biometric authentication is performed and the electronic key of the electronic device 10 authenticated as being used by a legitimate user is validated, this electronic device 10 shifts to a state in which an operational input from the user unlocking or locking the lock device 40 can be received. Accordingly, the user can make an operational input for unlocking or locking so that the lock device 40 can be unlocked or locked.

In this manner, even if a plurality of electronic devices 10 are registered and the number of spare keys has increased, a burden on the user managing a plurality of spare keys can be reduced by invalidating the status information of the electronic devices 10 on the basis of the distance. Accordingly, if the number of alternative keys is increased (the number of spare keys is increased) on the assumption of occurrence of a breakdown in the electronic device 10, a burden on the user managing a plurality of spare keys can be reduced, and therefore it is possible to improve the degree of freedom in increasing the number of alternative means when the electronic key breaks.

Meanwhile, in Step S504, when it is determined that the authentication results of biometric authentication has not been received (Step S511-NO in FIG. 8), the control unit 307 determines, in Step S510, whether or not a timeout period determined in advance based on the point of time when each of the electronic devices was invalidated has elapsed (Step S513 in FIG. 8).

If the timeout period has not elapsed (Step S513—NO in FIG. 8), the control unit 307 causes the processing to proceed to Step S511, and if the timeout period has elapsed (Step S513—YES in FIG. 8), it ends the processing.

Meanwhile, in Step S504, when all the active/inactive information from the plurality of electronic devices 10 is transmitted via the same wireless access point 20, it can be estimated that the plurality of electronic devices 10 are present at nearby places. For example, it can be estimated that the user carries all the electronic device 10.

When the distance between the detected locations is not longer than the distance determined in advance, that is, it is within a range of the distance determined in advance on the basis of the determination results of the location determination unit 309 (Step S504—NO in FIG. 8), the status information management unit 303a determines whether or not the time interval between the last communication time and the current time is within the allowable time (Step S505 in FIG. 8). Further, when the time interval between the last communication time and the current time exceeds the allowable time, the status information management unit 303a determines that the electronic key corresponding to the last communication time which has exceeded the allowable time is invalid and rewrites that the status information is invalid (Step S506 in FIG. 8).

Meanwhile, the status information management unit 303a determines the electronic key having the highest priority level as a valid key among the electronic keys other than the invalidated electronic keys (the electronic keys whose time interval between the last communication time and the current time has not exceeded the allowable time) (Step S507 in FIG. 8).

Further, if a valid key is selected, the lock device management unit 304 transmits the keyhole data corresponding to the validated electronic key to the lock device 40 through the communication unit 302. Further, the control unit 307 ends the processing.

According to the embodiment described above, when a breakdown or the like has occurred in the electronic device 10 storing the main key, the lock device 40 can be unlocked or locked using the electronic devices other than the electronic device 10 in which a breakdown has occurred, for example, an authentication device or the like attached to the electronic device 10 storing the spare key or the lock device 40. In this case, among the usable electronic devices 10, it is possible to validate one electronic device which can receive the active/inactive information in the key management server 30 and stores the electronic key having the highest priority level.

Accordingly, instead of causing all the plurality of electronic devices to be usable, only one electronic key is validated. For this reason, even when a plurality of spare keys are prepared on the assumption of a breakdown, it is possible to manage the usage state of the spare keys such that the spare keys are prevented from being used illegally by a third person.

In addition, according to the embodiment described above, each of the electronic devices 10 transmits the active/inactive information to the key management server 30 at regular intervals and updates the last communication time. Further, when it exceeds the allowable time so that the active/inactive information cannot be updated, the electronic key of the electronic device 10 whose active/inactive information could not be updated is determined to be unusable. Accordingly, the electronic device 10 whose active/inactive information has not been updated is regarded as an electronic device which cannot be confirmed regarding whether or not it can be used normally, and is invalidated. Among other electronic devices 10, the electronic device 10 having the active/inactive information which can be updated and the highest priority level can be validated.

In addition, according to the embodiment described above, the user can carry the electronic device 10 storing the spare key. Accordingly, even when the electronic device 10 storing the main key becomes incommunicable with respect to the key management server 30, the user carries the electronic device 10 storing the spare key. For this reason, the electronic device 10 storing the spare key can be prevented from being used by a third person. Accordingly, it is possible to reduce a situation in which the lock device 40 is unlocked or locked by a third person using the spare key. In addition, when the locations of the plurality of electronic devices 10 are away from each other by a certain distance or more, all the electronic device 10 can be invalidated. Accordingly, even if any of the electronic devices 10 is lost, stolen, or the like, the user can prevent the electronic key stored in the electronic device from being used without performing any special operation. In addition, regarding the invalidated electronic device 10, when it is confirmed that the user is an authentic user through biometric authentication, the electronic key of the electronic device 10 which has been subjected to biometric authentication is validated so that the lock device 40 can be locked or unlocked.

Next, an electronic key system SB according to a third embodiment will be described.

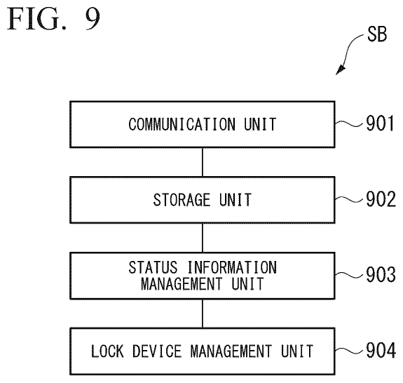

FIG. 9 is a schematic functional block diagram showing a constitution of the electronic key system SB according to the third embodiment.

The electronic key system SB has a communication unit 901, a storage unit 902, a status information management unit 903, and a lock device management unit 904.

The communication unit 901 repeatedly performs communication at intervals with a plurality of electronic devices having individual electronic keys assigned thereto to check whether communication is possible with the plurality of electronic devices.

The storage unit 902 stores an electronic key list stored for each piece of lock identification information for identifying a lock device, in which the electronic key list includes management target electronic keys, priority levels differing for each of the electronic keys, and status information indicating whether or not the electronic key is valid.

The status information management unit 903 writes that one electronic key based on the priority level is valid among the electronic keys assigned to the electronic devices on the basis of a result of communication performed by the communication unit 901.

The lock device management unit 904 assigns keyhole data for enabling at least one of locking and unlocking operations using the validated electronic key to the management target lock device.

The lock device management unit 904 assigns keyhole data for enabling at least one of locking and unlocking operations using the validated electronic key to the management target lock device.

In addition, a program for realizing the functions of the processing portions in FIG. 1 may be recorded in a computer-readable recording medium, and construction management may be performed by causing a computer system to read and execute the program recorded in this recording medium. Here, it is assumed that the term “computer system” includes an OS and hardware such as peripherals.

In addition, when “the computer system” uses the WWW system, it is assumed to include a homepage providing environment (or a display environment).

In addition, the term “computer-readable recording medium” indicates a portable medium such as a flexible disk, a magneto-optical disk, a ROM, or a CD-ROM, as well as a storage device such as a hard disk built into the computer system. Moreover, it is assumed that the term “computer-readable recording medium” includes recording media retaining a program for a certain time, such as a volatile memory inside the computer system serving as a server or a client. In addition, the foregoing program may realize some of the functions described above and may be able to realize the functions described above and a program which has already been recorded in the computer system in combination. In addition, the foregoing program may be stored in a predetermined server, and the program may be distributed (downloaded or the like) through a communication line in response to a request from other devices.

Hereinabove, embodiments of this invention have been described in detail with reference to the drawings. However, specific constitutions are not limited to these embodiments, and design and the like within a range not departing from the gist of this invention are also included.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

### EXPLANATION OF REFERENCES

10, 10a, 10b Electronic device
20 Wireless access point
30, 30A Key management server
40 Lock device
101, 301, 902 Storage unit
102, 302, 901 Communication unit
103 Active/inactive information management unit
104 Output portion
105 Input portion
106 Biometric information input portion
107 Biometric authentication portion
108, 307 Control unit
303, 303a, 903 Status information management unit
304, 904 Lock device management unit
305 Timepiece portion
306 Key registration portion
308 Detection unit
309 Location determination unit
310 Authentication result acquisition unit
S, SB Electronic key system

What is claimed is:

1. An electronic key system comprising:
a communication unit configured to repeatedly perform communication at intervals with a plurality of electronic devices, each of the plurality of electronic devices having a respective electronic key assigned, to check whether each of the plurality of electronic devices is not able to communicate with a key management server that manages the electronic key assigned;
a storage unit that stores an electronic key list for each piece of lock identification information for identifying a lock device, wherein the electronic key list includes management target electronic keys, priority levels differing for each of the electronic keys, and status information indicating whether or not the electronic key is valid;
a status information management unit configured to write that one electronic key based on the priority level is valid among the electronic keys assigned to the electronic devices on the basis of a result of communication performed by the communication unit; and
a lock device management unit configured to assign keyhole data for enabling at least one of locking and unlocking operations using the validated electronic key to the management target lock device.

2. The electronic key system according to claim 1,
wherein the status information management unit is configured to write that the electronic key having the highest priority level is valid among the electronic keys assigned to the electronic devices on the basis of a result of communication performed by the communication unit.

3. The electronic key system according to claim 1,
wherein the status information management unit is configured to write that the electronic key having the highest priority level is valid among the electronic keys whose most recent time at which communication was able to be performed by the communication unit is within a range of an allowable time based on a current time.

4. The electronic key system according to claim 3,
wherein when the most recent time at which communication was possible with the electronic device having the validated electronic key assigned thereto exceeds the allowable time, the status information management unit invalidates the validated electronic key and validates the electronic key having the highest priority level whose most recent time at which communication was possible is within the range of the allowable time among the remaining electronic devices.

5. The electronic key system according to claim 4,
wherein when communication is resumed with the electronic device invalidated due to exceeding an allowable time, the status information management unit validates the electronic key having a higher priority level of the priority level of the electronic key assigned to the electronic device with which the communication has been resumed and the priority level of the electronic key which is currently validated, and invalidates the remaining electronic keys.

6. The electronic key system according to claim 1, further comprising:
a detection unit configured to detect a location of the electronic device of each of a plurality of electronic keys associated with the same lock identification information; and
a location determination unit is configured to determine whether or not a distance of each of the detected locations is within a predetermined distance,
wherein if the detected location is not within the predetermined distance, the status information management unit invalidates all the electronic keys of the electronic devices on the basis of determination results of the location determination unit.

7. The electronic key system according to claim 6 further comprising:
an authentication result acquisition unit is configured to acquire, from the electronic device, authentication results of biometric authentication performed for the electronic device,
wherein the status information management unit is configured to validate the electronic key of the electronic device authenticated as being used by an authentic user in the authentication results among the electronic keys invalidated on the basis of the detected location not being within the predetermined distance, and the status information management unit is configured to invalidate other electronic keys on the basis of the determination results of the location determination unit.

8. An electronic key management method comprising:
repeatedly performing communication at intervals with a plurality of electronic devices, each of the plurality of electronic devices having a respective electronic key assigned, to check whether each of the plurality of electronic devices is not able to communicate with a key management server that manages the electronic key assigned;
storing, in a storage unit, an electronic key list for each piece of lock identification information for identifying a lock device, wherein the electronic key list includes management target electronic keys, priority levels differing for each of the electronic keys, and status information indicating whether or not the electronic key is valid;
writing in the storage unit that one electronic key based on the priority level is valid among the electronic keys assigned to the electronic devices on the basis of a result of communication performed by the communication unit; and
assigning keyhole data for enabling at least one of locking and unlocking operations using the validated electronic key to the management target lock device.
